(19) United States
(12) Patent Application Publication
(10) Pub. No.: US 2005/0239483 A1
(43) Pub. Date: Oct. 27, 2005

(54) Business event indicator

(75) Inventor: Marko Suoste, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/830,966

(22) Filed: Apr. 23, 2004

(51) Int. Cl. H04M 11/00

(52) U.S. Cl. 455/466; 455/415

(57) ABSTRACT

The invention relates to a transfer of an event based data between a backend server and a terminal. When an event is input to a server, the server makes an indication to a terminal via telephone network by calling shortly. The terminal identifies the call and launches a process for checking the event from the server. The invention relates to a method, a system as well as both to the server and the terminal. The invention relates also to corresponding computer program products. The event being transferred can be e.g. email or calendar mark.

### FIELD OF THE INVENTION

This invention relates generally to mobile terminals and particularly its collaboration with an event server. The invention relates to a transfer of an event based data from a server to a terminal.

### BACKGROUND OF THE INVENTION

Persons, such as employees, who want or are required to be reachable use mobile terminals for receiving contacts from others. Calls, SMS (Short Message Service) and MMS (Multimedia Messaging Service) messages reach such persons quite easily. Nowadays increasingly more contacts are made by emails, which are addressed to a person's business or home email account inbox (later called “mail account”). That kind of a contact is generally noticed if the corresponding person has available a suitable device for reading the email, available. However, not having such a device, the contact is left unnoticed till the person has an access to the mail account.

Unnoticed emails can become a problem particularly for business. One way for preventing important emails from lodging in the person's mail account, is to compose an automatic reply message (“out of office” reply message) telling about the absence of the recipient and the availability of other suitable communication channels, or to forward incoming emails into another mail account. These arrangements are helpful, but they are better suited for situations where the person is absent longer (e.g. during holidays) or does not want to read emails. Current mail systems enable another suitable method i.e. forwarding the emails to the mobile terminal of the person. This can be implemented from the email server side or from the terminal side. For example an international publication WO 00/02403 describes an arrangement for indicating a terminal of new email by sending a SMS message to the terminal. When the email server is in charge for forwarding emails, it sends a SMS message to the terminal for indicating the arrival of new email. After receiving the message, the user can launch the email program and read the email.

However, this kind of solution has such downsides, which can be acceptable with SMS messages but can be considered critical with emails, e.g. the transfer of the SMS message can be unreliable; it sometimes may take few hours to deliver the message, when the network is congested e.g. during peak seasons, such as Valentine's day, or due to some force majeure. Another downside is the pricing of SMS messages, for the price can be based per message such as in some operator networks. For example for a company employing several hundreds of persons, the price could easily rise quite high.

Instead of the server also the terminal can be configured to poll from time to time the email server for new emails. This can be done with a particular polling software (e.g. ActiveMail by Cibenix Ltd), which has been implemented into the terminal. However, it can be easily seen that this kind of arrangement may result in a large amount of unnecessary polls over the network as well as relatively huge battery consumption. It will be evident that the battery consumption increases in relation to the polls. Though the polling software is adjustable to poll the server every now and then (e.g. twice a day), but usually the few polls per day is not enough.

For limiting additional traffic in the network as well as for reading emails from the server more inexpensively, there is a need for an improved method for indicating emails to the terminal. One challenge relates to synchronization between terminal and server. This invention suggest a method for implementing it.

### SUMMARY OF THE INVENTION

The aim of the current invention is to provide such a method, which enables notifications of new email from the email server to the terminal. Another aim of the invention is to provide such a method, which is used not only with emails, but also with other markings and entries (referred as events) made to an event server. The method can be implemented in a way that is invisible to the user, and notification should be priced so that it would not produce unnecessary costs to the user.

The aims can be achieved by a method according to the invention, wherein a notification relating to an event (hereafter notification) from the server is transferred to a terminal via a telephone network by calling a circuit switched call. The notification is detected by the terminal, wherein a process for fetching the event from the server is launched. The notification is transferred by phone call, which is hung up before answering (rejected without answering). The method can be carried out by a system according to the invention and a computer program product. The invention further relates to a business method for providing a notification service.

The invention has considerable advantages compared to methods according to related art. For example notification of new email can be cheaper compared for example to the SMS notification methods of related art. The notification in some call areas can even be toll-free.

In addition, the power consumption may be reduced, because unnecessary polls are prevented. Also, when operating as an automatic process and therefore invisible for the user, the user experience may improve. But also the usability may increase even if the process, or selectively some parts of the process, is shown to the user.

### DESCRIPTION OF THE DRAWINGS

FIG. 1 illustrates in a simplified manner a flowchart according to the invention,

FIG. 2 illustrates an example of the relations of the elements operating according to the invention, and

FIG. 3 illustrates an example of signalling according to the invention.

### DETAILED DESCRIPTION OF THE INVENTION

In the detailed description of the invention email is used as an example of the typical use case. However, it should be understood that this invention is not limited solely to electronic mail or email items. The method according to the invention can be utilized with any markings or entries (events) that are made to the server and that need to be informed and even delivered to the user. In addition to emails, one suitable event is a calendar event as well as to-do-tasks.

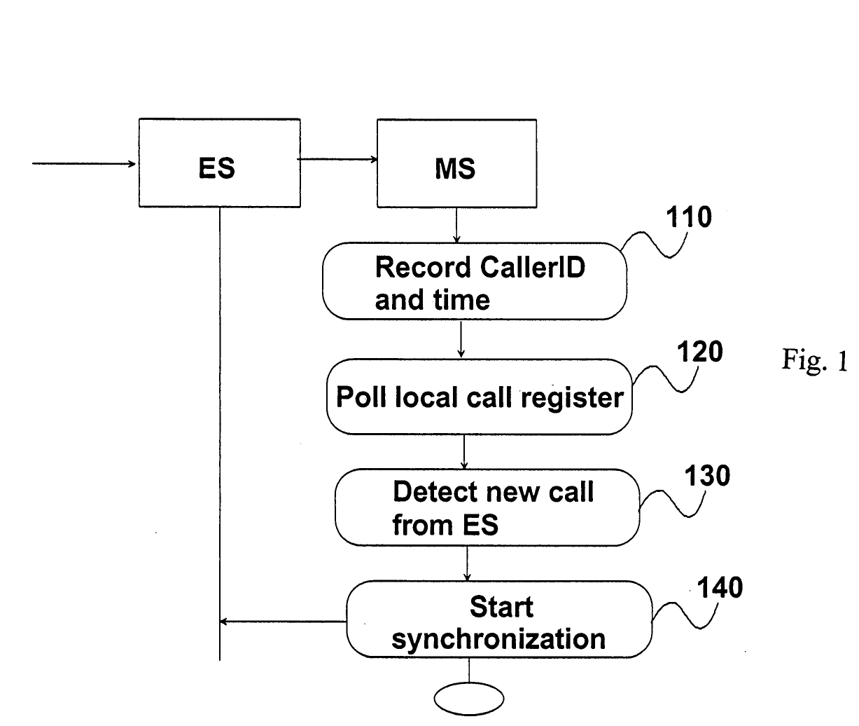

The basic steps for the invention are presented in FIG. 1. The main idea is to make a short call (notification) from the server ES to the user's terminal MS. The call is disconnected by the caller (the server ES) when the server notices that the connection to the terminal MS has been made (e.g. after less than 1 sec. from the connection). The caller ID of the server ES is identified and recorded (110) with time information by the terminal MS, but the terminal does not answer the call or rejects the call after identifying the caller. However, if the user unintentionally answers the call, the server is arranged to automatically disconnect the call, or a short pre-recorded message could be played for the user to inform about the reason for the call. Unanswered call is toll-free in most countries, whereupon the notification will be delivered free-of-charge. The terminal comprises a polling software (120), which detects the call from server (130) and launches synchronization software for checking the event (140). Naturally it is possible to profile the caller (the server) according to the basic mobile communication principles. For example the caller can be given its own ringtone or the terminal can be set to a tactile alert for a particular caller etc.

For enabling the process of the invention, the terminal is preset with a group of phone numbers, which are profiled for hidden call receive. The phone numbers relate to a preconfigured caller IDs (e.g. CNID, Caller Number Identification, CLID, Caller Line Identification) of each mail server that is configured to send a notification for marked events. Hidden calls are recorded by the terminal but they preferably do not cause ringing unless the user so desires. The notification call about new email may be so short that it does not reserve lines, but that it is noticeable by the terminal. The terminal records the caller ID and a time of the call to a local call register. The terminal comprises a polling software, which is configured to read the local call register. When the polling software detects the call from the server, it invokes a message synchronization procedure. After synchronization the terminal presents the email account to the user. The download of messages from the server is advantageously automatic, so it can happen in the background and may not require any actions from the user.

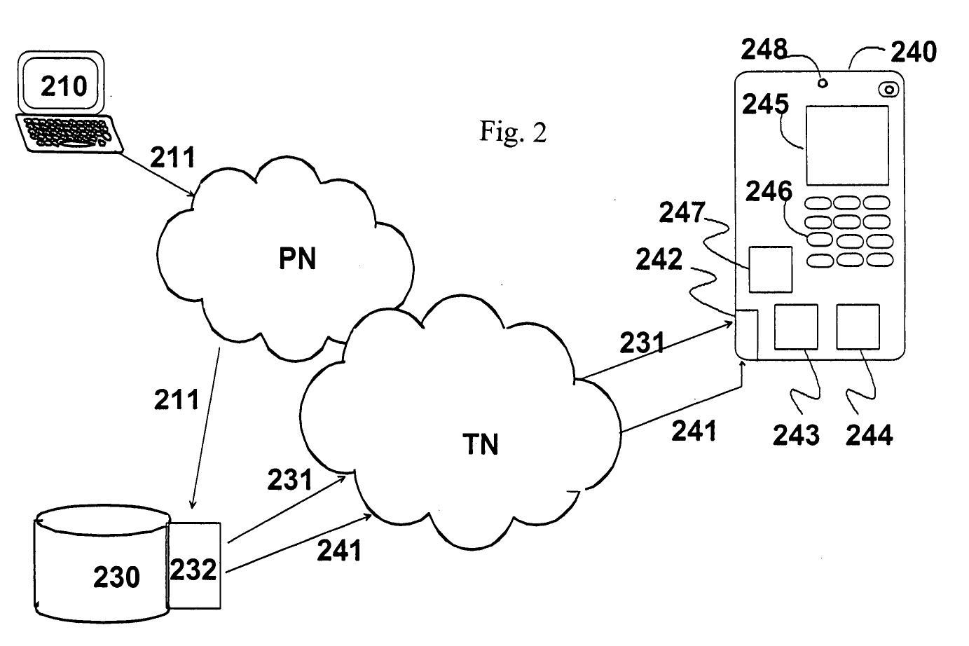

FIG. 2 illustrates elements according to the invention. A user at the personal computer 210, said user being called a sender, sends an email 211 to a user identified by an email address and accessing his/her mail account by means of a public network PN, said user being called a recipient. The server 230 or a unit functionally connected to said server having an interface 232 to the pubic network PN and to the telephone network TN detects and receives the email and detects also that the recipient has set an out-of-office reply active. The server 230 sends a notification to a terminal 240 of the recipient by making a relatively short phone call 231 to the terminal. The telephone network TN sends to the terminal 240 of the recipient a calling signal including the caller ID information (CID). The terminal 240 detects the signal by e.g. the communication element 242. The caller is identified by the terminal 240 from the caller ID information defining the caller. The terminal 240 records the caller ID for the purpose of being detected by a polling software which may be executed by e.g. the control element 243 of the terminal 240. After the terminal 240 has detected that the caller ID corresponds to any of the preconfigured caller IDs the terminal launches the synchronization process by e.g. the synchronizing element 244 and fetches 241 by the communication element 242 new emails from the server 230. It should be noticed, that the notification is not necessarily transferred for every incoming email, e.g. a burst of emails are considered as one email and notified all at once. The terminal can also be synchronized with more than one email server, each having different caller IDs. Then the user can configure the terminal, for example by the keypad 246 of the terminal or by some other means adapted to input configuring data, to use automatic synchronization for only some servers. Similarly, the server can be configured to notify only some emails being defined (filtered) by the user.

The terminal 240 also comprises a memory 247 for storing data, call register, profiling information etc. The terminal 240 may further comprise inter alia an alerting element 248 for informing e.g. alerts to the user, a display 245 for displaying information.

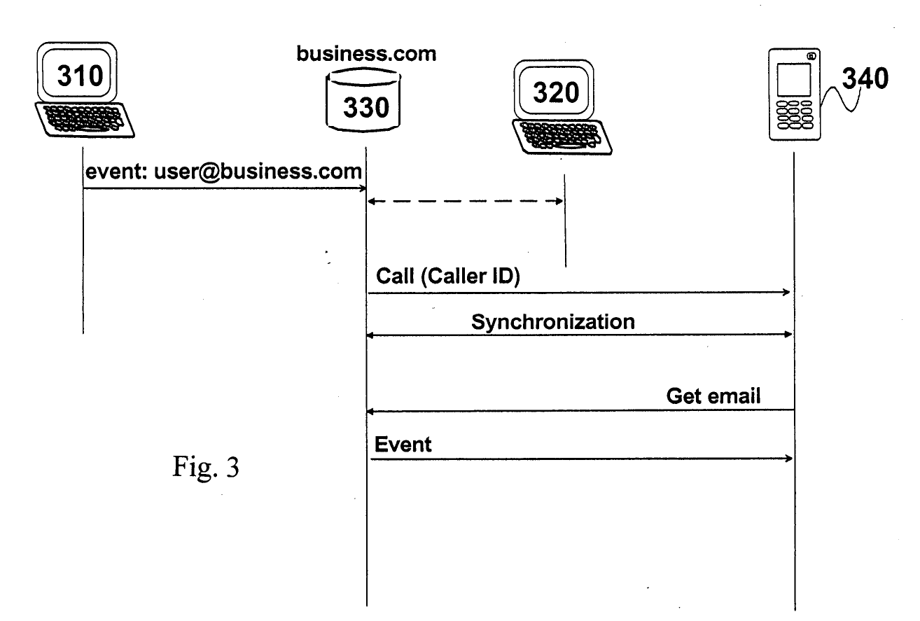

A signalling for the process is illustrated in FIG. 3. In the FIG. 3 sender 310 is going to send an event to the recipient's email account at the server 330. The event can then be read e.g. with a personal computer 320 or with the terminal 340. In the latter case the terminal 340 is configured to synchronize with the server 330 for fetching the event from the server 330. The sender can also place an event to the recipient's calendar. The notification is transferred similarly to the recipient.

As mentioned, emails and calendar events (e.g. tasks, to-dos, memos, appointments, anniversaries etc.) are not the only events that can be notified from the server. The invention can be utilized in business but also with any other situations where events occurring in the server need to be notified to the terminal.

The terminal discussed can for example be a portable device such as a mobile phone, a smart phone, such as Nokia's 9290 Communicator, PDA (Personal Digital Assistant) or similar advanced terminal. The server can be any network server, to which emails and other events are passed. The server comprises a telephone connector for making the notifications. The server can locate e.g. at the premises of the company or at user's home. Both the server and the terminal are configured to operate with the invention. The terminal is provided with a polling software operating in the terminal and with an email synchronization software configured to fetch emails from the server via network. The server is configured to make a short call after receiving a new event and noticing the absence of the recipient. The absence of the recipient can be asked from the email server or checked from the calendar. One skilled in the art will appreciate that the system may comprise other capabilities and functionalities, which provide suitably enhanced efficiencies for notifying about the emails.

The foregoing detailed description is provided for clearness of understanding only, and not necessarily limitation should be read therefrom into the claims herein.

1. A method for transferring event based data from a server to a terminal, an event being entered to a server, wherein the method comprises transferring a notification of the event to the terminal via telephone network by a call, identifying the call and launching a process for fetching the event from the server by said terminal.

2. The method according to claim 1, comprising disconnecting the call after a connection is made to the terminal.

3. The method according to claim 1, comprising profiling the call for hidden call receive by the terminal.

4. The method according to claim 1, wherein the process is a synchronization process.

5. The method according to claim 1, comprising notifying the event to the user.

6. The method according to claim 1, wherein said event is one of the following: an email, a calendar marking, to-do marking.

7. A system for managing events, said system comprising a server and a terminal being configured to use a network, said server comprising an interface for receiving events and an event account for storing said events, said terminal comprising communication element for fetching said events from said server, wherein the server further comprises an indicator means for making a call to said terminal for notifying about events, said terminal further comprising a control element for identifying said call and launching a process for fetching the event.

8. The system according to claim 7, wherein the indicator means is configured to operate after noticing an absence of a user.

9. The system according to claim 7, wherein the indicator means is configured to make a call and disconnect after a connection has been made to the terminal.

10. The system according to claim 7, wherein the terminal comprises a synchronizing element for synchronizing event based data with the server.

11. The system according to claim 7, wherein the terminal comprises a memory for saving the call information made by the server.

12. The system according to claim 7, wherein the terminal is configured to hidden call receive.

13. A terminal for fetching event based data from a server, said terminal comprising a communication element for forming a network connection to said server and for receiving a call, said terminal further comprising a control element for identifying said call and if the call came from the server, the terminal is further configured to launch a process for fetching data from the server.

14. The terminal according to claim 13, further comprising a memory for saving call related information.

15. The terminal according to claim 13, further comprising a profiling means for defining a hidden call receive for calls.

16. The terminal according to claim 13, comprising means for informing the event to the user.

17. The terminal according to claim 13, wherein said event is one of the following: an email, a calendar marking, to-do-marking.

18. The terminal according to claim 13, configured to disconnect the call after identifying said call.

19. The terminal according to claim 13, comprising synchronizing element for synchronizing event based data with the server.

20. An event server for transferring event based data to a terminal, said server comprising an interface for receiving events and for configuring a network connection to the terminal and an event account for storing said events, said server further comprising an indicator means for making a call to the terminal for indicating events and transferring said event based data to the terminal in a fetching process.

21. The event server according to claim 20, wherein the indicator is configured to operate after noticing an absence of a user.

22. The event server according to claim 20, wherein the server is configured to disconnect after a connection has been made to the terminal.

23. A computer program product for a server comprising computer readable instructions for identifying a recipient of an event and making a call to a terminal of that recipient via a network for indicating events to the recipient.

24. A computer program product for a terminal comprising computer readable instructions for forming a network connection with server, said computer program product further comprising instructions for identifying a call and if the call came from the server, launching a process configured to fetch event based data from the server.

25. A business method for providing a notification service for events occurring in a server, wherein the method comprises transferring event based data to a terminal in a fetching process by the terminal, informing the terminal about the events by a call, whereupon the terminal identifies the call and launches the fetching process for the event.
